(19) United States
(12) Patent Application Publication
(10) Pub. No.: US 2025/0209523 A1
(43) Pub. Date: Jun. 26, 2025

(54) NETWORKED SUPPLY CHAIN MARKETPLACE FOR THE CONSTRUCTION INDUSTRY

(71) Applicant: Matthew H. Williams, North Abington Township, PA (US)

(72) Inventor: Matthew H. Williams, North Abington Township, PA (US)

(21) Appl. No.: 19/055,640

(22) Filed: Feb. 18, 2025

Related U.S. Application Data
(63) Continuation-in-part of application No. 18/392,499, filed on Dec. 21, 2023.

(51) Int. Cl. G06Q 30/0601; G06Q 10/0835; G06Q 30/0251; G06Q 50/08; H04L 9/00

(52) U.S. Cl. CPC G06Q 30/0641; G06Q 10/08355; G06Q 30/0259; G06Q 50/08; H04L 9/50

(57) ABSTRACT

A novel networked supply chain marketplace system is described for managing construction resources employing several delivery vehicles, each having a Remote Computing Devices (“RCD”). The RCDs wirelessly receive and store information regarding the previous known history (“History”) of each portion of construction materials (“Lot”). The RCDs also monitor and store the delivery of Lots and merge the information into the History. Upon delivery of the Lot, the RCD transfers the History of the Lot to an RCD at the destination. The RCD also updates a remote central server to store the History of the Lot in a tamper-resistant, secure, distributed register. This History can be used as a chain of title for the Lot for environmental reports.

### CROSS REFERENCE TO RELATED APPLICATION

This application is a continuation-in-part of U.S. Non-provisional Utility Patent application “NETWORKED SUPPLY CHAIN MARKETPLACE FOR THE CONSTRUCTION INDUSTRY”, application Ser. No. 18/392,499, filed Dec. 21, 2023 that is incorporated into this application as if it were included in its entirety, except for any provisions which conflict with the current application.

### STATEMENT REGARDING FEDERALLY SPONSORED RESEARCH

Not Applicable.

### BACKGROUND

### 1. Field of Invention

The present invention relates to a mobile supply chain network for efficiently linking construction supplies, construction materials, equipment, and services to those in need of such resources. In particular, the present invention relates to a mobile supply chain network for efficiently linking supplies, construction materials, equipment, and contractors to those in need of such resources that minimize waste.

### 2. Description of Related Art

### Current System is Inefficient

A contractor building on a construction site paid to have about 100 triaxle loads of fill hauled to a remote dump site. He later found out, the day after they had hauled away the fill, that the neighboring property would have accepted it all. With a little more information, this contractor would have saved the time, effort, and cost of hauling these loads. Also, the neighboring property would have received its needed fill quickly and at a lower cost.

This situation is currently happening at many construction jobsites across the country, not only for fill, but also for building materials, supplies, equipment, and services.

Each truckload burned a significant amount of diesel fuel, adding to climate change. With the high cost of diesel fuel now, this was a waste of funds. Also, the shortage of trucking capacity tied up trucks that could have been put to better use.

When truckloads of material are delivered to a site, there is typically no information provided with the delivered material. Possibly, it may indicate the location where the material was loaded, with little additional explanations or information.

Currently, there is a need for a system in the construction industry that would more quickly and efficiently match those needing construction resources, and supplies with those nearby having these construction resources, delivering them by the most cost-efficient route, and keeping track of the chain of title of the construction resources.

### Supply Chain Delays

It is important in the construction industry to provide timely access to manpower, equipment, supplies, and other construction resources.

Being able to find exactly what you need to complete the job, has become more difficult due to supply chain shortages. Before COVID-19, accessing wood, soil, and other aggregates was easier. A contractor would visit their local big box retail chain and order the necessary construction resources. The construction industry took an extremely hard hit during the pandemic and the subsequent labor shortages that followed, causing major disruption and delays in the supply chain.

Now, builders are increasingly looking for more efficient ways to obtain the resources that they need. It would be beneficial to have a system that efficiently links those with construction resources with those needing construction resources.

### Difficult to Find Local Supplies and Material

When constructing a structure, there are many tasks to be performed. Take, for example, a company such as a national drug store chain headquartered in Rhode Island that would like to build another store in northeastern Pennsylvania. The contractor has little knowledge of resources near northeastern Pennsylvania.

The entity having final responsibility for completing the project will be referred to as the General Contractor (GC). Therefore, the GC would have to care of real estate matters, such as finding and purchasing or leasing land to build the structure.

The GC would have to obtain equipment to clear the land or sign up a contractor to clear the land.

It would be beneficial to have a system that would identify the locations of various local construction services and suppliers.

The GC will then need equipment to level the land and fill in low sections. Even if fill is found from a supplier, it must be trucked to the jobsite. Also, all construction resources must be acquired and trucked to the construction site.

Since the materials and equipment are bulky and heavy, it can be costly to transport these large distances. It would be beneficial to have a system that displays available local services and suppliers.

It would also be beneficial to have a system that displays local services and suppliers that are needed.

### Need for Local Contractors

Contractors are also required to perform environmental studies, erosion control studies, acquiring permits, excavating, drilling, blasting rocks, providing cranes, rigging, framing, welding, installing wiring, carpentry, stone masonry, plumbing, painting, roofing, floor installation, etc. These contractors are typically required to be licensed in the area where they work. Many of these Contractors charge a travel fee. Therefore, it is beneficial to acquire materials, equipment, and use local contractors' services near the construction site.

Each contractor (entity) may have or need any of the resources listed above. In reality, most entities both have and need resources.

It would be beneficial to have a system that displays available local contractors.

It would be beneficial to have a system that displays needed local contractors.

It would also be beneficial to have a system that displays contractors in a local area with construction materials, supplies, or equipment.

It would also be beneficial to have a system that displays contractors in a local area that need construction materials, supplies, or equipment, or construction services.

### Lack of Addresses

Many jobsites do not have a formal street address early in construction. The address is assigned later. Therefore, the delivery of materials, supplies, and construction services is problematic.

It would be beneficial to have a system that can define locations without the need for a formal street address.

### Communication Problems

Once the contractor finds the entities who will be working on the job, there is the problem of having them all effectively communicate with each other, as well as with the GC. The GC typically spends a lot of time notifying and directing various entities during construction. Several entities may provide, for example, paving equipment, all located at different locations that use different types of communications.

It would be beneficial to have a communication system that allows communication between specified entities invited to work on a jobsite.

Also, we would like to minimize the chances that one of the contractors incorrectly begins communicating with an entity working on a different jobsite or project, causing confusion. It is beneficial to have a system that identifies entities invited to work on a jobsite and allows them to communicate with each other.

### Human Error

Contractors currently manually estimate the amount of construction materials required for each task. For example, if there is a rectangular depression that the contractor needs to fill, the contractor manually calculates the volume to be the length times the width, times the depth, and converts this into cubic yards as an estimate. There are different formulas for different geometric shapes. If the wrong formula is used, the estimate will be incorrect. This may result in the contractor buying much more material than is required, or buying less than is required, causing the task to be delayed.

It would be beneficial if a simple calculator would reduce human error by automatically estimating the volumes of materials required for common fill shapes.

### History of the Materials

States are increasingly passing regulations requiring indications of any known pollutants or possible contamination of materials. Therefore, construction materials require an indication that the material was not loaded from a contaminated site. Information would also be required as to where the material travelled before being delivered. This chain of title information is currently not being delivered with the materials.

Currently, there is a need for an automated system to keep track of information relating to each payload, its history, where it goes, and the route it takes.

### BRIEF SUMMARY OF THE INVENTION

This invention is a new and novel mobile supply chain network for the construction industry.

Some entities have construction resources, such as materials, supplies, and equipment, and services that they would like to supply. Each specific resource that can be offered is referred to as a ‘Have’. For example, a cement company has a job that only requires ⅓ of a truckload. The entity can make a post indicating that it has ⅔ of a truckload of concrete that it can deliver on a specified day.

On the other hand, some entities may need a piece of construction equipment, such as a concrete leveler. This would be a ‘Need’ for the concrete leveler.

The current system allows each Supplier Entity to post their ‘Haves’ (materials and supplies that they have and want to sell or barter) to the entities signed up with the current system. Entities can also post their ‘Needs’ (materials, supplies, and services that they need) to the other entities signed up for the current system. It is possible for an entity to post both Haves and Needs and be a Provider Entities for some construction resources and a Requester for other construction resources.

The current system allows construction companies to sign up for an account and onboard their information. Only construction companies and those working in the construction industry may open an account. Others are restricted, resulting in pro-to-pro connections only. Restricting membership to construction entities filters out advertisers and others, which would result in many unwanted responses. The current system filters out the noise of unrelated businesses and services, as found in other internet searches.

Example. An internet search of “clean fill Scranton” will produce thousands of results varying in merit and substance. Many results will be completely unrelated to the desired information requested in the search. A search on the current invention for “clean fill Scranton” will produce only listings closely related to obtaining or getting rid of clean fill.

The current system integrates a user-created ‘Jobsite’ with ‘Haves’ and ‘Needs’. A Jobsite can associate specific ‘Haves’ and ‘Needs’ linked to real-time data to determine which ‘Needs’ and ‘Haves’ are active or have been fulfilled. This interactive updating helps the Entities understand the tasks completed or left to complete at a specific Jobsite within the app. This real-time updating allows for more accurate estimating of job status, potential completion, etc.

One ‘Have’ does not necessarily fulfill one ‘Need’. For example, if an Providing Entity needs 5000 pounds of gravel, it can be fulfilled by several entities, each providing a portion of the gravel until they reach 5000 pounds. The current invention allows entities to sell off small excesses from another Jobsite that would otherwise be wasted.

The current system incorporates a novel Calculator function. It allows the user to select shapes and add dimensions. It then calculates the cubic yards of fill required to fill the shape.

The calculator also estimates square footage and required amounts of concrete or asphalt to complete a job.

The calculator also converts the answers to other measurement units such as yardage, footage, and acreage.

The current invention may be embodied as a networked supply chain marketplace having a plurality of Remote Computing Devices (RCDs) associated with a construction entity, that can receive and transmit data to other computing devices through communication links.

A Providing Entity having an excess construction resources available at a location desires to sell to (or barter with) a Requesting Entity. The system also includes a plurality of RCDs each associated with a Requesting Entity requesting construction resources. These RCDs are coupled to, and in communication with at least one RCD of a Providing Entity offering excess construction resources. The Providing Entity posts a description of the material being offered, the amount, and the location. The Requesting RCDs are capable of asking questions of, receiving answers from, negotiating with, and accepting offer(s) of construction resources from the Providing RCDs. After one of the Requesting RCDs accepts the construction resources, the Providing RCD indicates that these construction resources are no longer available.

The current invention may be embodied as a networked supply chain marketplace system for the construction industry having a plurality of RCDs, each associated with a construction Entity, whereas one of the Entities is a General Contractor (GC) in charge of completing construction on a jobsite.

The RCD receives and transmits the GC's determination of which Entities will be on a team working on the jobsite, wherein each RCD is capable of displaying an interactive map showing the locations of jobsites and other construction entities that are offering construction resources, and construction entities that are requesting construction resources, and each RCD has an internal Memory capable of storing information of its associated Entity's jobsites, excess construction resources that it has for the jobsite, and the construction resources it needs to complete work on a jobsite.

Each RCD also is capable of interacting with its associated Entity to create and send posts offering excess construction resources that it has that it would like to offer to other Entities. Each RCD also is capable of interacting with its associated Entity to create and send posts requesting construction resources that it needs from other Entities.

The system also includes a Server coupled to the plurality of RCDs, is adapted to receive indications from the RCD associated with the GC on which Entities are authorized to work on the jobsite, and will be part of the private network; set up connections to allow team members to freely communicate with each other in the private network; receive posts from the RCDs and determine which other RCDs should receive the posts, and provide the Posts to those remote Entities that should receive them; and connect RCDs to allow them to communicate with each other, upon request.

The current invention may also be embodied as a networked construction resource marketplace having a first plurality of remote computing device (RCD) each associated with a Requesting Entity requiring construction resources, the RCD capable of posting a description of the construction resources needed with a location where the construction resource is needed, a second plurality of Remote Computing Devices (RCDs) each associated with a Providing Entity having excess construction resources that it intends to provide with a location of where the excess construction resource is located; and a server coupled to and communicating with the RCDs of the Requesting Entities and the RCDs of the Providing Entities. The Server can provide visual representations of locations and descriptions of the construction resources being offered, and locations and descriptions of the construction resources needed. The Server is also capable of calculating routes and cost of delivery between various locations of excess construction resources and locations where these resources are required. The Server is capable of connecting RCDs of Requesting Entities with RCDs of Providing Entities to communicate, communicating descriptions of the construction resources to the Providing Entities and Requesting Entities. The Server is also capable of coupling RCDs to allow Requesting Entities to communicate with Providing Entities and complete deals. The Server is also capable of calculating routes between specific locations of the excess construction resource and location where the resource is required and calculating the costs for delivery. The Server is also capable of tracking the locations of the construction resources as they are delivered and providing visual representations of progress of delivery of the construction resources.

The current invention may be embodied as a networked supply chain marketplace having a plurality of Supplier Entities, each having a Remote Computing Device (RCD), with a prestored history profile of the construction resources intended to be liquidated, the Supplier Entities having equipment to advertise the history profile, location and costs of the construction resources to other entities on the supply chain marketplace, such as a plurality of Requester Entities on the networked supply chain marketplace, that require construction resources. The Requester Entities each have an RCD capable of receiving the advertisements of at least one Supplier Entity on the marketplace, and capable of communicating with at least one Supplier Entity. A server is coupled to the Supplier and Requester RCDs capable of estimating at least one cost-efficient route from a pickup location defined by the Supplier Entity to the delivery location defined by the Requester Entity, taking into account truck size, bridge height, tire chain, restrictions, road restrictions and other traffic restrictions.

Wherein, the Requester entity selects a Supplier Entity from which to acquire the construction resources, based at least in part on the materials profile, the construction resources total cost. A delivery system delivers the construction resources from the selected pick-up location to the desired destination location and monitors the time/location of the construction materials as they are delivered. (Please note that the driver also has the capability of overriding the calculated route.) This information is added to the history profile of the construction materials. The delivery system is connected to the server which includes a secure, storage system for acquiring and storing profiles of construction materials, the pick-up and delivery locations, the time/location during delivery of the construction materials. The server stores the history profile in a secure, distributed register. The secure distributed register may employ block chain technology.

The current invention may also be embodied as a delivery system that retains a secure chain of title for individual lots of construction materials (“Lots”) having a plurality of delivery vehicles each able to transport construction materials, where each delivery vehicle includes a mobile communication device (RCD) capable of wirelessly communicating with a base. The base is a server which directs each delivery vehicle to pick up construction materials (Lots) and identifies the location of each Lot, and at least one delivery location. It also determines a cost-efficient route from pick up to delivery for each Lot. The RCDs collect the History of each Lot, updates and provides this History to an RCD at a delivery site when the Lot is delivered. The RCD updates a secure distributed register of the server to provide a chain of title for each Lot.

The current invention may also be embodied as a method of accurately calculating transportation costs and delivering a portion of construction materials (“Lot”) while accurately maintaining a chain of title. This method begins by identifying a pickup location for a Lot, and its delivery location, identifying a valid route from the pick-up location to at least one delivery location, acquiring known past history of each Lot (“History”) being picked up and storing the History. Monitoring the delivery of the Lot and adding this information to the History. Then storing the History with a central server when the Lot is delivered to the delivery location in a secure distributed register to identify a chain of title.

### BRIEF DESCRIPTION OF THE DRAWINGS

The invention's advantages described in this application will become more apparent when read with the exemplary embodiment described in the specification and shown in the drawings. Further, the accompanying drawings and descriptions that follow, like parts are indicated throughout the drawings and description with the same reference numerals, respectively. The figures may not be drawn to scale, and the proportions of certain parts have been exaggerated for the convenience of illustration.

FIG. 1 is a simplified system diagram of one embodiment of the major elements of a networked supply chain marketplace for the construction industry according to the current invention.

FIG. 2 is a simplified flowchart showing the major steps of the functioning of one embodiment of a networked supply chain marketplace for the construction industry, according to the current invention.

FIG. 3 illustrates the elements and Entities of the networked supply chain marketplace selected to be on the team and were invited into the construction site's private network.

FIG. 4 is a screenshot of a Remote Computing Device (“RCD”) of an embodiment of the current invention showing an interactive map with icons indicating the locations of jobsites, entities that need construction resources, and those that are offering construction resources.

FIG. 5 is a screenshot of an RCD of an embodiment of the current invention allowing a user to search for specific construction resources within a defined radius.

FIG. 6 is a screenshot of an RCD embodiment of the current invention showing the Entity's jobsites.

FIG. 7 is a screenshot of an RCD of an embodiment of the current invention, a Post by an Entity offering “Lay Down Yards/Land for Lease”.

FIG. 8 is a screenshot of an RCD of the current invention showing a tutorial indicating how to create a ‘Have’ Post.

FIG. 9 is a screenshot of an RCD of the current invention showing a ‘Need’ Post for Mobile crushing and screening services.

FIG. 10 is a screenshot showing the bottom of the page of FIG. 9.

FIG. 11 is a screenshot of an RCD of an embodiment of the current invention showing the “Calculators” page.

FIG. 12 is a screenshot of an RCD of an embodiment of the current invention showing different shapes that may be chosen for calculating a volume of a shape.

FIG. 13 is an illustration of several vehicles travelling along calculated routes to pick up and deliver construction materials while keeping track of the chain of title of each lot of construction materials.

FIG. 14 illustrates the elements and Entities of another embodiment of networked supply chain marketplace compatible with an automated materials yard.

FIG. 15 is an illustration of a vehicle travelling along calculated routes to pick up and deliver construction materials at an automated material yard, that keeps track of material lots picked up or delivered, and the chain of title of each lot of construction materials.

### DETAILED DESCRIPTION OF THE INVENTION

The present invention will now be described in detail by describing various illustrative, non-limiting embodiments with reference to the accompanying drawings. The invention may, however, be embodied in many different forms and should not be construed as being limited to the illustrative embodiments set forth herein. Rather, the embodiments are provided so that this disclosure will be thorough and will fully convey the concept of the invention to those skilled in the art. The claims should be consulted to ascertain the true scope of the invention.

The terminology used herein is to describe particular embodiments only and is not intended to be limiting of the invention. As used herein, the term “and/or” includes any and all combinations of one or more of the associated listed items. As used herein, singular forms “a,” “an,” and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits, and each can also be used in conjunction with one or more, or in some cases all, of the other disclosed techniques. Accordingly, for clarity, this description will refrain from repeating every possible combination of the individual steps in an unnecessary fashion. Nevertheless, the specification and claims should be read with the understanding that such combinations are entirely within the scope of the invention and the claims.

### 1. Theory

As indicated above, there are currently problems locating accurate supplies, materials, and services (resources) for the construction industry. They rely on archaic and inaccurate means of communication, special calculations, data storage, and acquiring needed resources to complete a job.

If one is picking up, hauling or dumping clean fill, currently there is no history of where the fill originated and if it was mixed with other fill. This history is important in determining if there are any contaminates, or if any contaminates were added by mixing it with other fill.

The history should be accumulated for each batch of clean fill and provided to each successive entity taking custody to create history information packets indicating the chain of custody.

It is also difficult to verify if an information packet has been modified and defeats its purpose. Therefore, if the history information packet can be modified, it would defeat the point of tracking the history. The history information packets would have no value. Therefore, each history information packet must be stored in a way that identifies if it has been modified. One known way is a distributed block chain register.

The current invention addresses and fixes these shortcomings.

Some larger projects require many truckloads of fill. Sometimes this may take a while. Currently, there is at least one person allowing trucks into the project site. They also have to verify that the fill is acceptable. They then have to direct the trucks where to dump, keep records of what was dumped and when.

As indicated above, it would be beneficial to keep the history information packet for each lot dumped and keep all history information packets with the project site. A person at the site may be responsible for acquiring the history of each lot. This becomes quite time consuming and costly to have a person present at the project site to perform all these duties.

Therefore, the present invention discloses a system that automatically manages and runs a project site accepting clean fill.

Soon there will be regulations where each project site would be required to identify where all of the fill originated, where it was transferred and be able to verify that there are no contaminants in any of the lots dumped into a project site. The clean fill information must be verifiable and tamper-proof. Therefore, the use of history information packets in block chain would be a great way of meeting these requirements.

### 2. Implementation

The current invention may be implemented in several different ways based on the end user's individual requirements.

A new and novel networked supply chain marketplace is discussed herein allowing for efficient materials, supplies, equipment, and services exchange between construction entities. In the following description, for purposes of explanation, numerous specific details are set forth in order to provide a thorough understanding of the present invention. It will be evident, however, to one skilled in the art that the present invention may be practiced without these specific details.

The present disclosure is to be considered an exemplification of the invention and is not intended to limit the invention to the specific embodiments illustrated by the figures or description below.

### Operation of the System

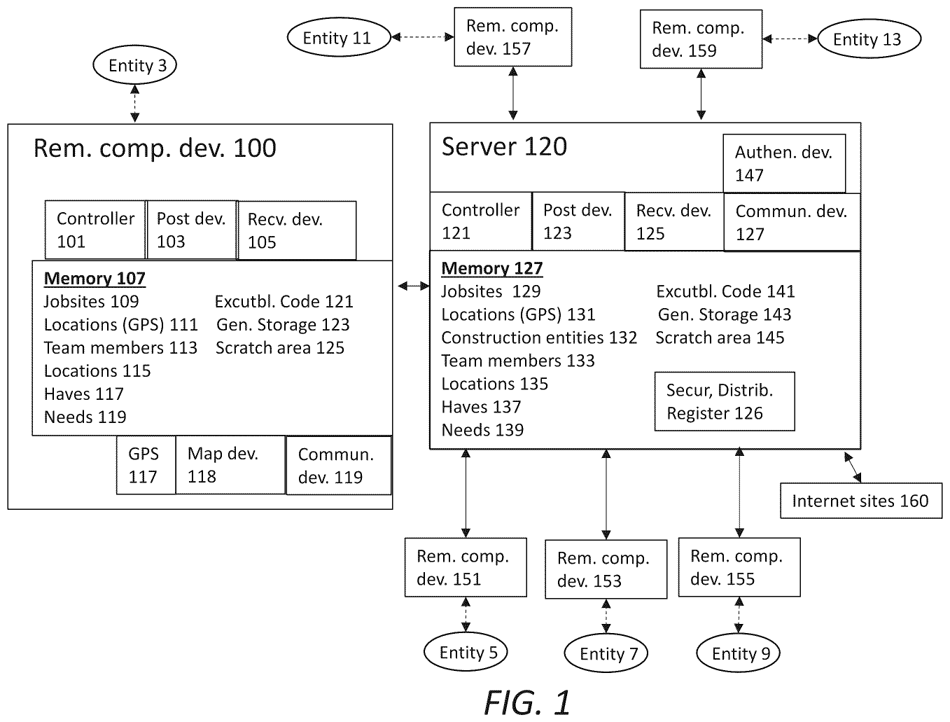

FIG. 1 shows a simplified system diagram of one embodiment of a networked supply chain marketplace for the Construction Industry according to the current invention.

A plurality of Remote Computing Devices (“RCDs”) 100, 151-157 are each used by a plurality of construction Entities 3, 5, 7, 9, 11, 13. They joined this network to either acquire or provide construction materials, equipment or services. When acquiring, it can be purchasing resources, bartering for resources, purchasing equipment, renting equipment, or bartering for equipment. Providing can be selling, or bartering out materials/supplies, selling, bartering out, or renting out equipment. Construction materials, supplies, equipment, and services may be collectively referred to as “construction resources”. (Only verified construction entities are allowed to join the network. This reduces the amount of irrelevant communication and spam on the network.)

Entities 3, 5, 7, 9, 11, and 13 may have materials, supplies, and equipment that they would like to sell, rent, or barter. Each construction resource that an Entity has is referred to as a ‘Have’. Entities may also require certain construction resources to complete a jobsite construction. Each of these needed resources is referred to as a ‘Need’.

Many entities will have both ‘Haves’ and ‘Needs’. Each ‘Have’ or ‘Need’ can be treated independently, or may be merged to offset costs.

Below is a table listing various construction resources. This Table is being provided to explain the construction resources that can be exchanged but is not an exhaustive list. Other related resources will be considered to be within the scope of and fall under the ‘spirit’ of this invention.

TABLE 1
CONSTRUCTION RESOURCES
MATERIALS, SUPPLIES,
EQUIPMENT
I Have/I Need:
Clean Fill
Asphalt
Block
Concrete
Brick
Dirt
Gravel and Rock
Other
Equipment for Rent
Asphalt Equipment
Concrete Equipment
Excavation Equipment
Heavy Equipment
Snow Removal Equipment
Tree Service Equipment
Trucks
Other
Equipment for Sale
Asphalt Equipment
Concrete Equipment
Excavation Equipment
Heavy Equipment
Snow Removal Equipment
Tree Service Equipment
Trucks
Other
Organic Materials
Leaf & Lawn Debris
Stumps
Firewood logs
Woodchips
Other
Real Estate
Garage Space
Land For Sale
Lay Down Yards/
Land For Lease
Portable Office
Self Storage
Other

Some materials, supplies, equipment and services are needed, which are typically not provided by other contractors. These resources are shown in TABLE 2.

TABLE 2
ADDITIONAL CONSTRUCTION
RESOURCES
I Need/I Need:
Jobsite Safety
Signs and Barricades
Traffic Control
Trench Safety
Other
Jobsite Support Services
Cleaning Service
Drone Operations
Jobsite Security
Equipment Repair/Mobile Mechanic
Portable Toilets
Septic Service
Video Monitoring
Retail & Wholesale Supplies
Asphalt
Building Materials
Bulk Rock Salt
Fuel
Green House/Nursery
Hardware Store
Landscape Supplies
Masonry & Concrete
Plumbing Supplies
Other
Sanitation & Recycling
Roll Off Dumpsters
Scrap Yard
Other
Trucking & Transportation
Dump Truck
Flatbed
Hotshot
Lowboy
Roll Off Dumpsters
Towing
Water Truck
Other

TABLE 3 shows services that are needed for construction (‘Needs’) and those entities that are offering to supply these services (‘Haves’).

TABLE 3
CONSTRUCTION RESOURCES
SERVICES
I Have/I Need:
Concrete
Crane and Rigging Services
Dock Builder
Drilling & Blasting
Electrician
Environmental
Erosion Control
Finish Carpentry
Flooring Installer
General Contractor
Hardscaping
Heavy Highway
Home Builder
HydroVac Excavation
Insulation
Land Clearing
Land Developer
Landscaping
Logging
Mason
Mechanical
Mobile Crushing & Screening
Oil and Gas
Other
Paving
Painter
Plumbing
Pool installer
Remodeling
Roofing
Excavation & Site Work
Utility
Stone Mason
Solar Installation
Striping & Sealcoating
Welder

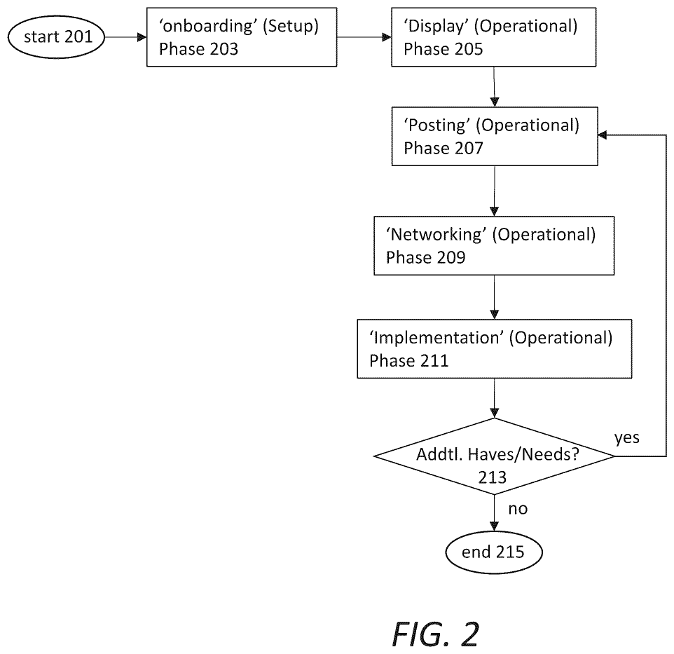

The functioning of the current system will be described below in the context of FIGS. 1 and 2. The process begins in FIG. 2 at the “start”, step 201.

### Onboarding

In step 203, the system enters the setup phase by performing an ‘onboarding’ function.

To join the current system, an Entity 3, using RCD 100, contacts Server 120 through Communication device 119 through a network such as a cellular network and/or the Internet to Communication device 127 of Server 120.

RCD 100 employs at least a Controller 101, Post device 103, Receiver device 105, GPS 117, Communication device 119 that may upload and run executable code 121, and other information stored in General storage 123 of Memory 107.

Server 120 employs at least a Controller 121, Post device 123, Receiver device 125, Communication device 127, and an authentication device 147 that may upload and run executable code 141 and other information stored in General storage 143 of Memory 127.

### Authentication

Server 120 then performs authentication with Authentication device 147 to determine if Entity 3 is a construction Entity. (In an alternative embodiment, Authentication device 147 may also be an external Software as a Service (SaaS) authenticator.)

If Entity 3 is verified as a construction Entity, it is then requested to provide information about the user, the user's company, the type of Entity, its location, contact information, a description of what it has that it would like to sell, rent, or barter, descriptions of its ‘Needs’ that I would like to acquire.

This information is stored in Memory 127 of Server 120. (It may also be stored in Memory 107 of RCD 100 for faster start-ups.)

The above process is performed for all initial entities which would like to be part of the system. After the requested information of all initial entities has been received and stored, the setup phase ends, and the Operational phase begins.

### Display

Step 205 is the first operational step.

In step 205, information of Jobsites 129, information acquired for construction entities 132 may be sent to RCDs 100, and 151-159 to be displayed as icons on a map according to preselected filtering, representation at their respective locations, 131, 135 and 135 by a Map device 118 of RCD 100.

Each RCD screen should have buttons to change the entities being displayed interactively. For example, pressing the “Haves” button only displays Provider Entities on the map, indicating that they have construction resources to offer. Similarly, pressing the “Needs” button only displays Requester Entities on the map indicating that they need construction resources. The locations on the map should indicate the geographic locations of the entities. The distances from the jobsite may also be displayed.

Distance is one parameter considered when choosing which Supplier Entity to engage, as indicated in the “Background” above. Other parameters can be considered in choosing a Supplier Entity to engage. In an embodiment, entities can rate each other or provide “Likes”. Since Server 120 is involved with most of the system's actions, it can keep track of Posts, Invites, Likes, and Views. It also has information presented by the onboarding process. Server 120 also can acquire public information through connections to Internet sites 160.

Therefore, Server 120 can send various information to overlay on the map displayed to the Entities. For example, one embodiment may display the number of times an Entity is clicked to view its information. In another embodiment, it can be the number of ‘Likes’.

Since larger Entities may receive more views, on average as compared with small businesses, one can normalize the views or likes for the company size. (This information is provided by onboarding or can be found on various public internet sites.) The number of views divided by the company size would be a parameter that can be displayed on the map in another embodiment.

Since information gets ‘stale’, icons showing resources posted earlier are older. Icons for more recent Posts should be displayed as more prominent (brighter, larger, or have a higher number on them) than icons for resources posted earlier, in another embodiment of the invention.

Also, in still another embodiment, the amount of the material, supply, or equipment should have a relation to the icon displayed. Similarly, the value of the material, supply, or equipment should have a relation to the icon displayed. The icons may be made more prominent (brighter, larger, or have a higher number on them) for larger amounts of material.

In another embodiment, the number of Likes can be time weighted. For example, a ‘Like’ two months ago has half of the value of a ‘Like’ today. This valuation gives more importance to more recent ‘Likes’.

The Entity may be able to choose how to display the icons on the map or may activate other screens having additional information on the entities. The prominence of the displayed icon may be a composite of several variables, such as:

$$\begin{matrix}= ( views ) / ( age of the Post ) \\ = ( views ) / ( size of the Entity ) \\ = ( Invites / ( age of the Invite ) \\ = ( Invites / ( size of the Entity ) \\ = ( resource value ) / ( age of the Post ) \\ = ( resource value ) / ( size of the Entity ) \\ = ( resource size ) / ( age of the Post ) \\ = ( resource size ) / ( size of the Entity ) \\ = ( Likes ) / ( age of the Post ) \\ = ( Likes ) / ( size of the Entity ) \\ = ( Likes ) / ( current month ) \\ = ( Invites ) / ( current month )\end{matrix}$$

Or similar composites.

### Posting

In step 207, entities are allowed to make Posts. The current system allows a broadcast system where each entity can ‘Post’ the resources that an entity is offering for sale, lease, or barter.

Post device 103 of RCD 100 can interact with Entity 3 to select a construction resource that it requires (a ‘Need’ 119) stored in Memory 107 and send it through Communication device 119 and a network to Communication device 127 of Server 120.

Controller 101 recognizes this as a request for posting a ‘Need’ and broadcasts the Post to all entities. In an alternative embodiment of the system, Controller 101 only sends the Post to entities that match filter variables preset by the Posting Entity. In another embodiment, Controller 101 analyzes all of the ‘Haves’ 137 stored in Memory 127 of Server 120 relating to the resources of the attached entities. It notifies entities that may have resources that match the ‘Need’.

Similarly, Post device 103 of RCD 100 can interact with Entity 3 to select a construction resource that it would like to offer (a ‘Have’ 117) stored in Memory 107 and send it through communication device 119 and a network to communication device 127 of Server 120.

Controller 101 recognizes this as a request for posting a ‘Have’ and broadcasts the Post to all entities. In an alternative embodiment of the system, Controller 101 only sends the Post to entities that match filter variables preset by the Posting Entity. In another embodiment, Controller 101 analyzes all of the ‘Needs’ 139 stored Memory 127 of Server 120 relating to the resources of the attached entities. It notifies those entities which may need resources that match the ‘Have’.

The current invention allows for any two entities to engage in private communication. Private communication allows the entities to negotiate the sale or barter of resources privately.

### Defining Jobsite

If an Entity having a resource enters into a deal with an Entity working on the jobsite, the entities are invited into a private network for the jobsite. Each jobsite can have its own private network.

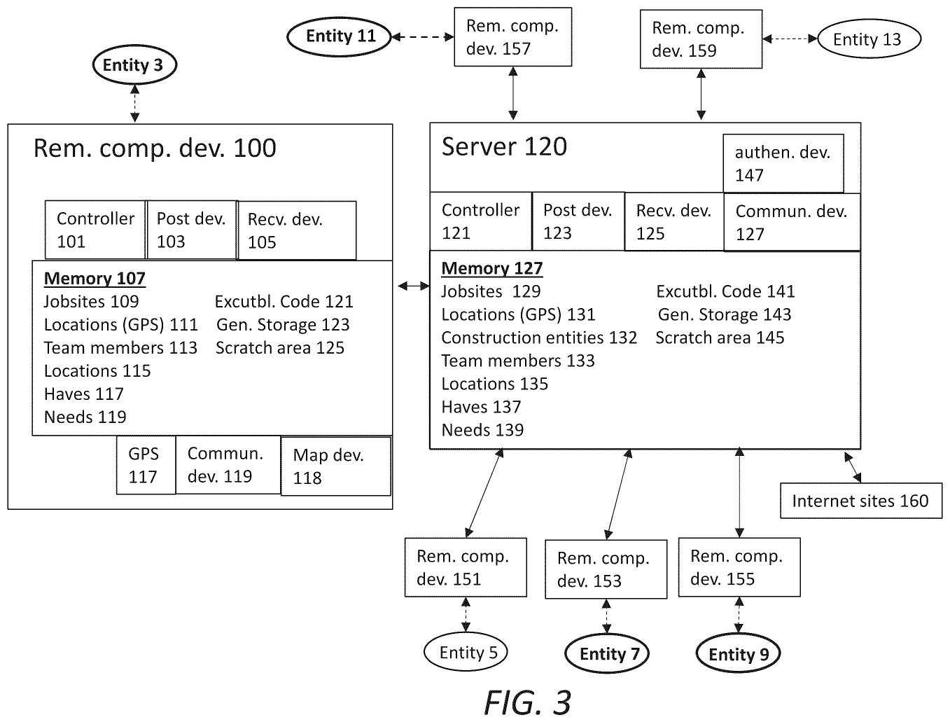

FIG. 3 illustrates elements and Entities of the networked supply chain marketplace that were selected to be on the team and were invited into the jobsite's private network.

In step 211, Entities 3, 7, 9, and 11 are invited as team members into the jobsite network. In one embodiment, information of team members 113, 133 is stored in Memory 107 of computing device 100 and Memory 127 of Server 120. This process results in a private networking group. Team members can communicate with all other team members in a broadcast mode or with specific team members of a specified type, category, etc. For example, a team member can message all paving contractors invited to work on the jobsite. This selective communication saves a tremendous amount of time for the contractor to explain the responsibilities of other subcontractors without providing unnecessary communications to other team members and minimizes confusion.

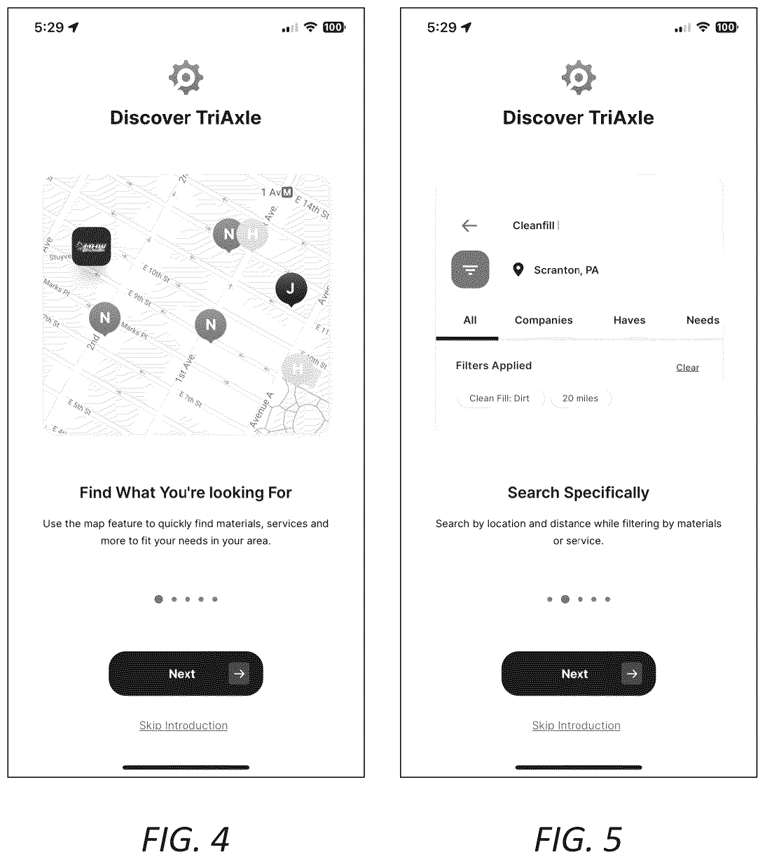

FIG. 4 shows a screenshot of an RCD, such as a cellphone of the current invention showing an interactive map with icons “N” indicating the location of a construction resource that is needed, an “H” icon indicating the location of a construction resource that is being offered, and a “J” showing the location of a jobsite. The current invention uses a Global Positioning System (GPS) system and Geolocation Features allowing users to interact with a map to find materials, supplies, equipment, services and other resources close to their local area.

The GPS triangulated map that displays all active jobsites, companies, and the requests that they need from other users. The map feature utilizes the phone's cellular, wireless, and GPS communications to accurately determine the exact location of each user regardless of the lack of a physical mailing address or other limitations common within the construction industry.

FIG. 5 is a screenshot of an RCD of the current invention allowing a user to search for specific construction resources within a defined radius. In this case, the Entity searched for any entities offering “Clean Fill Dirt” within a 20-mile radius of “Scranton, PA”.

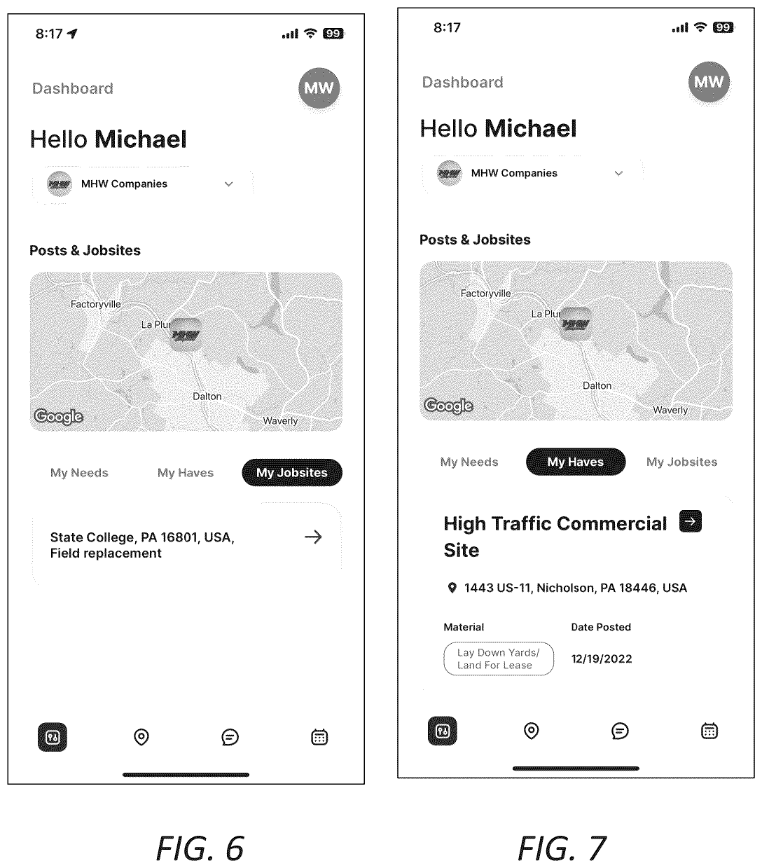

FIG. 6 shows a screenshot of an RCD of the current invention with an interactive map showing the “Dashboard” display indicating a jobsite at “State College, PA 16801, USA. The display indicates that this is a “Field replacement”.

FIG. 7 is a screenshot of an RCD of the current invention indicating where users post that it is offering “Lay Down Yards/Land for Lease” located at “1443 US-11, Nicholson, PA 18446 USA” to all on the current system. This ‘Have’ Post indicates that this is a “High Traffic Commercial Site”. This ‘Have’ Post was published on Dec. 19, 2022.

All communications within the invited private network, blueprints, photos, files, and data are secure since only invited users can collaborate.

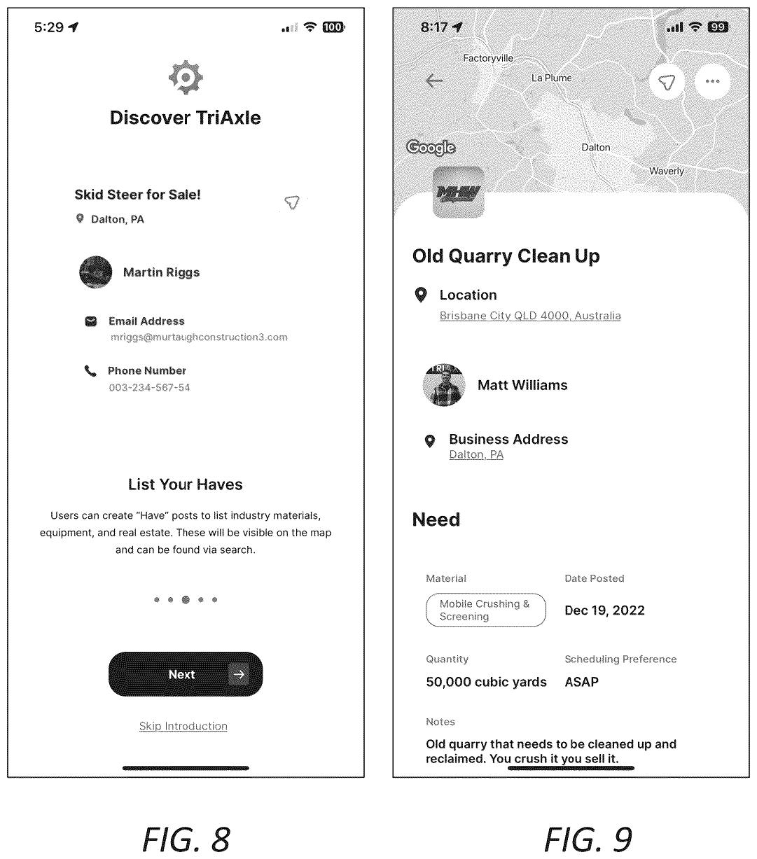

FIG. 8 is a screenshot of an RCD of the current invention showing a tutorial indicating how to create a ‘Have’ Post. In this draft Post, Martin Riggs offers a Skid Steer for Sale. This Post will be published to all entities in the current system.

The ‘Have’ Post feature allows Provider Entities to market the resources that they have and can provide to others immediately.

FIG. 9 is a screenshot of an RCD of the current invention showing a ‘Need’ Post for a Contractor that does “Mobile Crushing & Screening” to clean up an Old Quarry Clean Up ”. The Contractor is requested to start as soon as possible (ASAP). This job should result in 50,000 cubic yards of crushed stone that the Contractor crushes and sells. Matt Williams in Dalton, PA is responding to this Need Post.

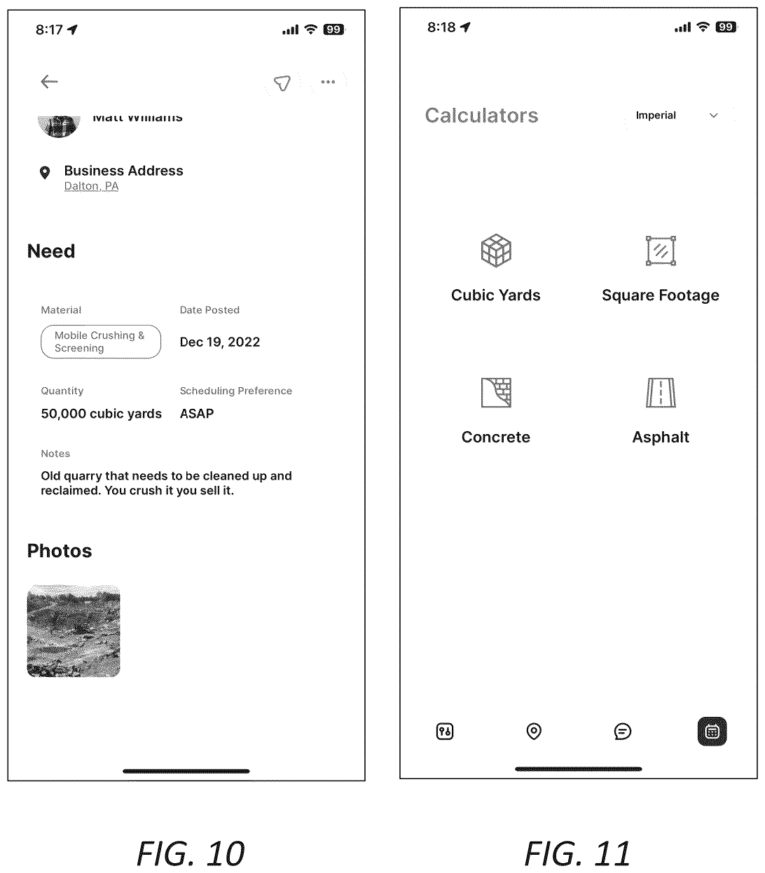

FIG. 10 is a screenshot showing the bottom of the page of FIG. 9.

FIG. 11 is a screenshot of an RCD of the current invention showing the “Calculators” page with buttons for calculating cubic yards, square footage, and amount of concrete and asphalt.

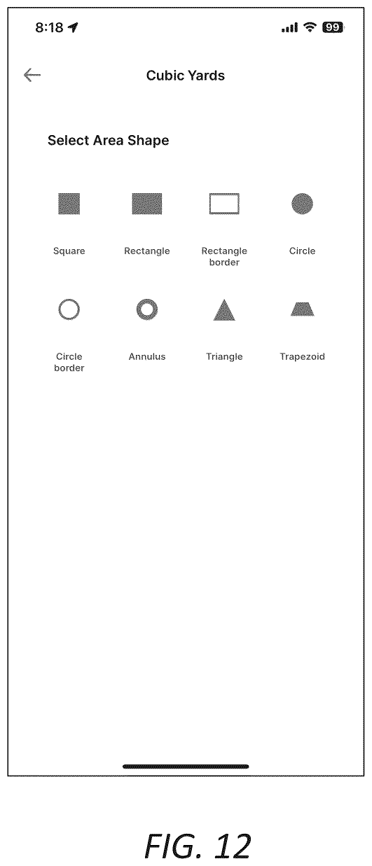

FIG. 12 is a screenshot of an RCD of the current invention showing different shapes that may be chosen for calculating a volume of a shape.

These can calculate two-dimensional square footage, such as is required for determining an area to pave, or three-dimensional volumes based upon the shape of the volume to fill. For example, an Entity would select the “Cubic Yards” button on the screen shown in FIG. 11, then select the shape that best approximates the shape of the depression that needs to be filled. For example, if the depression has a substantially annular shape, “Annulus” is selected as the Area Shape in FIG. 12. The system then prompts the Entity to enter the approximate radius of the inner radius and then the outer radius as well as an approximate depth. It will then calculate the approximate fill required in the units that fill is typically sold (cubic yards).

In an alternative embodiment, the chain of custody of all materials is maintained. Currently, there are states that require a chain of custody for soil and clean fill. Chain of custody information is intended to track contaminated soil and other construction materials.

GPS or standard route tracking can keep track of each delivery truck (“Vehicle”), and a clock can keep track of time so that we can track where each Vehicle was during the day.

The delivery vehicles may have weight sensors to indicate when they were filled with material(s).

If the information of the weight sensors is provided to the vehicle that can communicate with at least one RCD, the RCD can monitor and store not only the location of the vehicle over time, but how much it was carrying at each point in its travel.

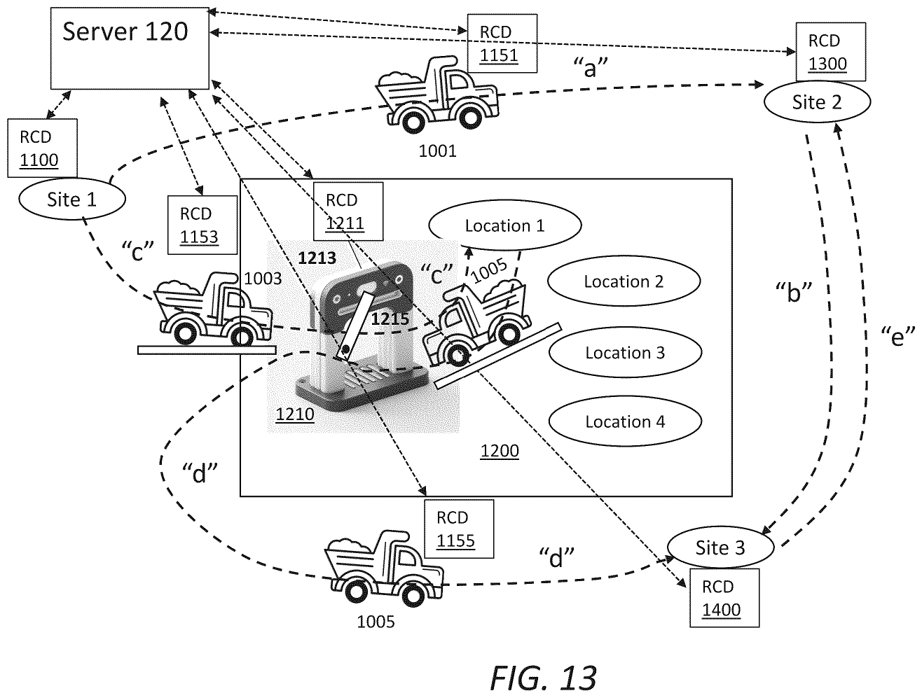

FIG. 13 is an illustration of several vehicles travelling along calculated routes to pick up and deliver construction materials while keeping track of the chain of title of each lot of construction materials.

For example, at least one cost-efficient route is calculated for a truck (Vehicle) 1001 to pick up construction materials at Site 1 and deliver them to Site 2. One of these calculated routes is selected and used. RCD 1100 is provided with the material type to be picked up at Site 1, the type of material being picked up, amount, weight, past history, description of any contamination, and any other information relevant to the cleanliness of the material at Site 1 being picked up (“History Packet”). This History Packets may include any previous contamination testing done at the site, previous, or current results, any other materials dropped off at this site, and their Histories Packets which may include their previous locations and previous testing results.

History Packets relating to the material are provided to the Requestor prior to loading Vehicle 1001 to allow the Requestor to accept or reject the construction materials.

If accepted, the History is loaded onto RCD 1151 of Vehicle 1001.

The construction materials are loaded onto Vehicle 1001. Weight sensors or vehicle scales may be used to keep track of the weight of construction materials loaded into Vehicle 1001. (Alternatively, if no weight sensors are present on the Vehicles, they may be weighed upon entering a site and exiting a site to determine the increase or decrease in weight. This measured weight may be used to verify if the correct amount of construction material has been loaded or delivered.

RCD 1100 then tracks locations/time as Vehicle 1001 travels along selected route “a” to Site 2.

Once Vehicle 1001 reaches Site 2, it communicates with an RCD 1300 at Site 2. If everything checks out, Vehicle 1001 is allowed into Site 2 to unload the requested amount of material at Site 2. Preferably, there is a computing device at Site 2, RCD 1300 that is connected to an automated sensor system at Site 2. This automated sensor system may be any conventional data communications link, preferably wireless RCD 1100 that downloads all the information acquired for this lot of material, including the route (locations/times) followed from Site 1 to Site 2 to RCD 1300 to keep as information relating to this delivery (Lot) of construction material. Either RCD 1100 or RCD 1300 communicates this information for this lot to remote server 120.

An automated sensor system 1210 used in Materials Yard 1200 can be used that is similar to the conventional E-Z PASS system used on highways. An overhead bridge 1213 sets up a changing magnetic field interrogation zone. The RCD 1153 of a Vehicle 1003 has prestored History Packet information. As the vehicle 1003 and RCD 1153 pass through overhead bridge 1215 (and through the interrogation zone), the RCD 1153 transmits transport information to RCD 1211 connected to the overhead bridge 1215.

(Other known conventional methods of wireless data communication may also be used.)

If only a portion of a load is delivered to Site 2, and the remainder is intended for Site 3, Vehicle 1001 then follows another calculated route “b” to Site 3 to drop off another load. When unloading, RCD 1300 updates the Transit Information with the locations/times of travel along route “b”, then downloads the updated History to RCD 1400 at Site 3.

Since the construction material dropped off at both Sites 2 and Site 3 are from the same load, the Material Histories, except for the additional travel along route “b”, are the same.

In an alternative embodiment, Vehicle 1001 can have separate compartments to hold more than one separate Lot of construction material. In this embodiment, Vehicle 1001 can pick up a first lot at Site 1 and store the History of Lot 1 as History 1 in RCD 1151.

It can then travel along route “a”, storing the locations/times along the route to Site 2. It can load a second Lot from Site 2 in a second, separate compartment on Vehicle 1001. The history of Lot 2 is stored on RCD 1151 as History 2.

Vehicle 1001 then travels along route “b” to Site 3. Its travel location and time is monitored and stored in both History 1 and History 2.

At Site 3, Vehicle 1001 can unload either or both lots and download the corresponding History for those Lots dropped at Site 3 to RCD 1400.

In still another embodiment, a Vehicle 1003, having an RCD 1153, loads material (Lot1) from Site 1. The entire existing History for this Lot is downloaded from RCD 1000 to RCD 1153 on truck 1003 when loading the construction material at Site 1.

Vehicle 1003 travels along route “c” to a Supply Yard 1201. As Vehicle 1003 and RCD 1153 enter Supply Yard 1201, they pass under (or near) the interrogation bridge 1213 which has electronics capable of wirelessly communicating data in both directions between an RCD 1211 and the RCD 1153 of Vehicle 1003. Vehicle 1003 is authenticated.

If properly authenticated, RCD 1153 notifies RCD 1211 what Lot(s) are being delivered and their sizes. RCD 1211 has logic to calculate how much space is required and assigns available Location(s) to Vehicle 1003 to unload the Lot(s).

An indication of which Vehicles are intended to later pick up the lots being delivered is also communicated from RCD 1153 to RCD 1211.

Histories are communicated from RCD 1153 to RCD 1211 for Lot(s) being delivered to the Supply Yard 1201.

Vehicle 1003 then goes to the assigned Location(s) and unloads the Lot(s) there.

Vehicle 1003 then is weighed exiting Supply Yard 1201. This weight is communicated to RCD 1211 that has logic to determine if the weight is approximately correct. If so, it actuates gate 1215 to allow Vehicle 1003 to exit.

For pick-ups, a Vehicle 1005 enters the Supply Yard 1201. It is authenticated by communicating information from its RCD 1155 to RCD 1211. If correctly authenticated, information of the location, construction materials and Histories of the Lot(s) that are to be loaded onto Vehicle 1005 are provided from RCD 1211 to RCD 1155.

Vehicle 1005 then goes to the identified Location(s) and loads the Lot(s) of construction materials.

Vehicle 1005 then is weighed exiting Supply Yard 1201. This weight is communicated to RCD 1211 that has logic to determine if the weight is approximately correct. If so, it actuates gate 1215 to allow Vehicle 1005 to exit.

RCD 1211 calculates the amount of space required for each of these Lots being delivered separately and notified 1153 where (which Location (2) to store the Lot. It then assigns one or more locations 1201-1204 for the Lot(s) to be stored.

Upon leaving material base, Vehicle 1003 and RCD 1153 identify themselves through interrogation bridge 1213 to RCD 1211. RCD 1153 then verifies or updates RCD 1211 with the location information where it unloaded the Lot(s).

All the information relating to the Lots delivered is sent to remote server 1120, which may provide the availability of various these construction materials posted by Providers to other users. Server 120 also provides the requests of Requesters for various construction materials, all as described in this document above.

Vehicle 1005, having an RCD 1155, follows route “d” into Supply Yard 1200 and passes through interrogation bridge 1213. RCD 1155 communicates with RCD 1211 requesting to pick up one or more lots stored in Supply Yard 1200. RCD 1211 then indicates location(s) where each Lot is stored. RCD 1211 also downloads the current profiles of the Lots intended to be taken by Vehicle 1005 into RCD 1155.

Vehicle 1005 then loads one or more Lots at the locations indicated by RDC 1211, making sure that these are stored in separate bins and are not comingled.

As Vehicle 1005 then exits Supply Yard 1200, interrogation bridge 1213 and RCD 1211 communicate with RCD 1155 to verify what Lot(s) were loaded, the construction materials loaded, their weight, and their profiles.

Vehicle 1005 then follows route “d” to Site 3 to unload at least one of the lots it is carrying. As with all lots, the locations and times of the route are monitored and added to the profiles of all lots being transported.

At Site 3, RCD 1155 unloads at least one Lot and downloads the History of the Lot unloaded to RCD 1400 at Site 3. Now RCD 1400 has these Lots and their complete Histories showing the chain of command from their initial loading Site to their final destinations. This information may be used to show the complete chain of title of the materials.

In an alternative embodiment of the current invention, location 1 of FIG. 13 may be a project site that requires multiple loads of clean fill. During the sales/purchase or bartering sessions, a requesting entity, such as entity 3 of FIG. 1 that is associated with location 1, may post requests from post device 103 of RCD 100 for multiple loads of clean fill to server 120 of FIG. 1. Server 120 then employs post device 123 to forward these posts to at least one of the other entities 5, 7, 9, 11 and 13. One or more of these entities can respond with information on the cost, location, and amount of clean fill available. In this case the requester entity 3 requested secure history information packet from each responding entity to verify the degree in which the fill is “clean”. As indicated above, this must be sent in a tamper resistant form to guarantee the information has not been changed.

The requesting entity 3 considers the clean fill material offered by each providing entity, the cost of the materials, the route, the cost of delivery, estimated date/time of delivery when determining which entities to purchase the clean fill from. The requesting entity 3 then decides on purchasing the clean fill from one or more of the providing entities. This will also determine the route for delivery, how many deliveries and the estimated dates/times of the deliveries.

Entity 3 transmits an entry code to each of the selected entities to enter the project site. These codes may be time limited so that they are only active on the intended delivery date/time. If an entity is intended to provide multiple loads, the time limit is adjusted to all the deliveries, but not to allow the trucks back into the project site (location 1) once the deliveries have been completed.

An example is if vehicle (truck) 1053 is loaded at site 1 with the clean fill and follows route “c” to Materials Yard 1200. Once truck 1003 reaches Materials Yard 1200, it passes through gate 1215 that reads information from RCD 1053 attached to truck 1003. RCD 1211 converses with RCD 1053 to verify that truck 1003 is carrying the correct amount of the clean fill purchased. RCD 1211 also requests, receives and verifies that the history information packet is acceptable. Once these are verified, RCD 1211 requests the entry code from RCD 1053. If that is a correct code for truck 1003, an automated age is opened allowing truck 1003 to enter.

Upon exit from the Materials Yard 1200, truck 1003 is weighed to verify that the proper amount of clean fill was dumped. If all checks out, RCD 1211 opens the gate 1213 to allow the truck 1003 to leave.

If there are inconsistencies, an immediate notification is sent to the requesting entity 3 through RCD 100 indicating the exact inconsistency. Requesting entity 3 may then override the gate 1213 allowing truck 1003 to exit Materials Yard 1200. Alternatively, Requesting Entity 3 is connected through server 120 to RCD 1053 of truck 1003 to allow a voice conversation between Requesting Entity 3 and the driver of truck 1003 to resolve any discrepancies.

In this way the system can allow multiple loads of clean fill to be deposited with little or no personnel required, creating a cost-efficient system.

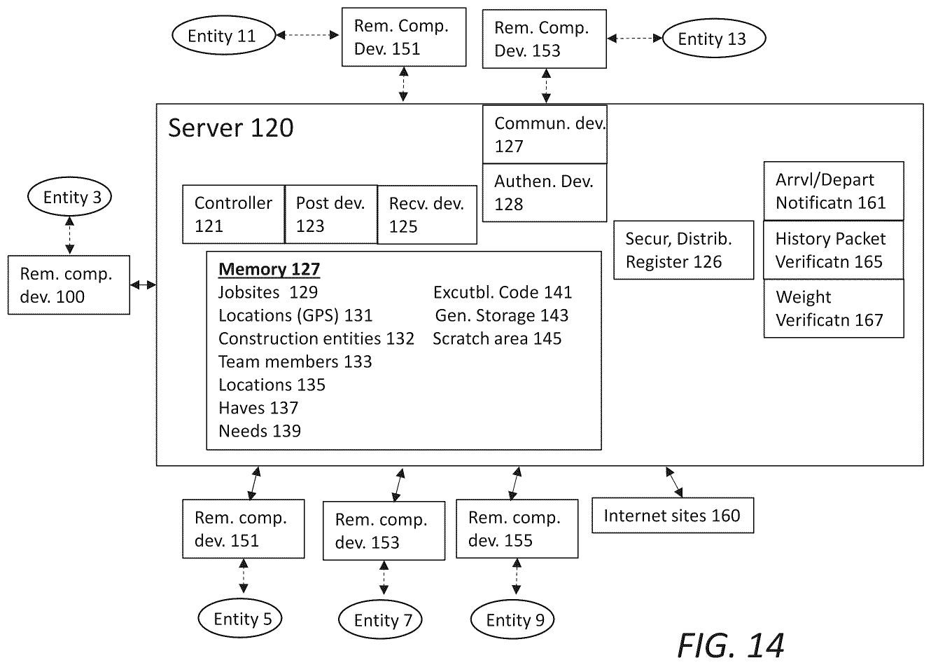

FIG. 14 illustrates the elements and Entities of another embodiment of networked supply chain marketplace compatible with an automated materials yard.

In another embodiment, offers for sale of fill, entities 7., 9 and 11 create posts that include quality history of the fill, which indicates the past history, its quality, and previous locations. This quality history is stored in a secure distributed register 126 of server 120 which may be a block chain registry. This registry allows others on the system to examine and verify the authenticity of the quality history.

Entity 3, provides its RCD 100 with the desired amount of fill and minimum quality of fill required.

The amounts available (lots), locations, and quality of each lot are offered by entities having this material such as Entity 7, Entity 9, and Entity 11 on the system.

The RCD 100 iteratively determines which offers could be combined to provide the required amount of fill of at least the required quality level.

RCD 100 then determines the overall cost of each combination. It does this by first ruling out Entities which are not offering fill of at least the minimum required quality. For example, if Entity 7 is offering fill which does not meet the minimum required quality indicated by Entity 3.

It then estimates the cost by starting with the posted cost of the material.

It then calculates the size of the truck or trucks required to transport the fill.

If there are only a few Entities that have the required quality, the estimated costs can be determined by identifying the size of the trucks required, the route the trucks are required to take (due to road, bridge and tunnel restrictions).

If there are many Entities that are offering fill of at least the required quality, then a cost estimations are done for a predetermined number of the closest Entities, thereby assuming that they will have the lowest transportation costs.

Alternatively, the cost estimates may be done for a predetermined number of the least expensive material costs posted.

In still another embodiment, Entity 3 may specify a maximum radius from a given location, such as a construction site. Cost estimates are then performed for a predetermined number of Entities within the maximum radius.

It is possible that some of the Entities do not have available enough of the fill required. In these cases, then RCD 100 of Entity 3 will compute the cost of two or more Entities providing small portions of the fill. The estimate is the sum of these several lots from a number of Entities.

RCD 100 determines how much will come from each location, the size of the trucks required. It will then determine which routes allow the vehicles for each of the combinations and calculates the costs to deliver by these routes. The costs for each route include the cost of the trucks used, their distances driven, tolls, and other related transportation costs. It then determines which combinations are the least costly and recommends that Entity 3 purchase one of these combinations.

If there is not enough fill being offered having at least the minimum quality required by Entity 3, RCD 100 may request that Entity 3 change the amount of fill required, the minimum quality level, or opt to try to make the purchase at a later date.

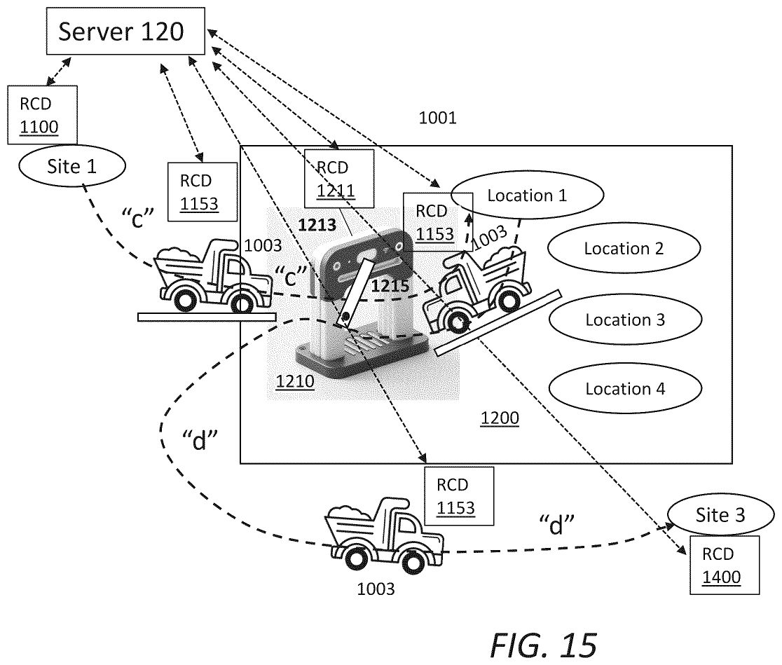

FIG. 15 is an illustration of a vehicle travelling along calculated routes to pick up and deliver construction materials at an automated material yard, that keeps track of material lots picked up or delivered, and the chain of title of each lot of construction materials.

After Entity 3, buys clean fill, it may interact with a ‘smart’ materials yard 1200. The vehicle 1003 has an RCD 1153 that can wirelessly communicate with other RCD, read sensors, perform calculations, wirelessly bill or pay money to other RCDs, and actuate mechanisms, such as gates. Therefore, it is possible to have an unmanned, automated materials yard 1200 having an automated sensor system 1210 in which vehicle 1003 passes through interrogation bridge 1213 to read a transaction ID from RCD 1153 of vehicle 1003 to RCD 1211. RCD 1211 then passes this information to server 120 that identifies an earlier transaction of the supply chain marketplace system (shown in FIG. 14). This transaction indicates that vehicle 1003 is picking up 1.5 tons of fill of quality level 5 at location 1 within the materials yard 1200.

The gate 1215 is opened by RCD 1211 to allow vehicle 1003 to enter onto a scale to weight the vehicle. The vehicle 1003 is also weighed on its way out to identify the change in weight. The change in weight indicates the amount of material delivered (or removed).

Muh of this information is shared with server 120. Server 120 also has financial calculation, payment and banking capabilities. RCD 1211 can credit an account for the deliver of fill, it can charge other accounts for the removal of material, or it can verify payment for fill taken.

These calculations are performed and the combinations with the least overall costs are suggested to Entity 3, before he/she makes any offers. Entity 3 may select one of these suggested combinations of purchases or override it and make different purchases.

Even though functions were described as being performed in the server 120, other embodiments may exist that perform many of these functions in the RCDs, as can be envisioned by one of ordinary skill in the art.

While the present disclosure illustrates various aspects of the present teachings, and while these aspects have been described in some detail, it is not the intention of the applicant to restrict or in any way limit the scope of the claimed systems and methods to such detail. Additional advantages and modifications will readily appear to those skilled in the art. Therefore, the teachings of the present application, in its broader aspects, are not limited to the specific details and illustrative examples shown and described. Accordingly, departures may be made from such details without departing from the spirit or scope of the teachings of the present application. Moreover, the preceding aspects are illustrative, and no single feature or element essential to all possible combinations may be claimed in this or a later application.

What is claimed is:

1. A networked supply chain marketplace comprising:
a) a plurality of Provider Entities, each having a Remote Computing Device (RCD), with a prestored profile of the construction resources intended to be liquidated, these Provider Entities have equipment to advertise the profile, location and costs of the construction resources to other entities on the supply chain marketplace;
b) a plurality of Requester Entities on the networked supply chain marketplace, that need and have requested construction resources, each comprising:
an RCD capable of receiving the advertisements of at least one Supplier Entity on the marketplace, and capable of communicating with at least one Supplier Entity;
c) a server coupled to the Provider and Requester RCDs capable of estimating at least one cost-efficient route from a pickup location defined by the Supplier Entity to the delivery location defined by the Requester Entity, taking into account truck size, bridge height, road restrictions and other traffic restrictions;
d) wherein the Requester Entity selects a Supplier Entity from which to acquire the resources, based at least in part on the materials profile, the construction materials total cost;
e) a delivery system for delivering the construction materials from the selected pick-up location to the desired destination location and for monitoring the time/location of the construction materials as they are delivered and adding this information to the history profile of the construction materials;
f) wherein the delivery system is connected to the server which includes a secure, storage system 126 for acquiring and storing profiles of construction materials, the pick-up and delivery locations, the time/location during delivery of the construction materials.

2. The networked supply chain marketplace of claim 1, wherein the delivery system comprises:
a. a plurality of delivery vehicles capable of transporting construction materials over a selected route to a destination location;
b. a vehicle RCD on each delivery vehicle that acquires the history profile and current location from the Supplier Entity RCD, the desired location from the Requester Entity RCD, monitors the time and location as the construction materials are transported from its current location to its destination location; and
c. stores this information at the server in a secure distributed register.

3. The networked supply chain market place of claim 1, wherein:
the RCD requesting resources can screen out Suppliers posting offers for resources that do not meet the minimum quality, and generate a reasonable number of estimates from the remaining Suppliers.

4. The networked supply chain marketplace of claim 3, wherein the RCD generates estimates by estimating the truck size required, the shortest available route allowed to deliver the resources.

5. The networked supply chain market place of claim 3, wherein the RCD creates cost estimates of fill from a plurality of Suppliers.

6. The networked supply chain marketplace of claim 1 wherein the prestored profile of the RCDs includes a history of any environmental actions or reports each tagged by date of the construction materials.

7. The networked supply chain marketplace of claim 3 wherein the tamper-proof, secure distributed register is a block chain register.

8. A delivery system that retains a secure chain of title for individual lots of construction materials comprising:
a. a plurality of delivery vehicles each able to transport construction materials,
b. each delivery vehicle comprising a mobile communication device (RCD) capable of wirelessly communicating with a base;
c. wherein the base is a server which directs each delivery vehicle which construction materials (Lots) to pick up, the location of each Lot, at least one delivery location and a cost-efficient route from pick up to delivery of each Lot;
d. wherein the RCDs collect the History of each Lot, updates and provides this History to an RCD at a delivery site when the Lot is delivered, and updates the secure distributed register of the server.

9. The delivery system of claim 8, wherein the server is adapted to consider restricted routes, weight of bridges, clearances, size of trucks required to calculate the cost-efficient route.

10. The delivery system of claim 8 wherein the RCD updates the History of each Lot as to the time and location of the Lot as it is being delivered.

11. The delivery system of claim 8 wherein the secure, distributed register of server employs blockchain technology.

12. A method of accurately calculating transportation costs and delivering a portion of construction materials (“Lot”) and accurately maintain chain of title, comprises the steps of:
a. identifying a pickup location for a Lot, and its delivery location;
b. identifying a valid route from the pick-up location to at least one delivery location;
c. acquiring known past history of each Lot (“History”) being picked up and storing the History;
d. monitoring the delivery of the Lot and adding it to the History;
e. storing the History in a tamper-resistant distributed register on a central server when the Lot is delivered to the delivery location.

13. The method of accurately calculating transportation costs of claim 12 wherein the tamper-resistant, secure distributed register is a block chain register.
